(19) United States
(12) Patent Application Publication
(10) Pub. No.: US 2002/0159445 A1
(43) Pub. Date: Oct. 31, 2002

(54) Non-blocking switching system and switching method thereof

(75) Inventor: Shigeyuki Yanagimachi, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/131,640

(22) Filed: Apr. 23, 2002

(30) Foreign Application Priority Data
Apr. 25, 2001 (JP) 126844/2001

(51) Int. Cl. H04L 12/66

(52) U.S. Cl. 370/355; 370/388

(57) ABSTRACT

An object of the present invention provides an inexpensive three-stage switching system which performs detailed switching at a packet level in a manner similar to packet switching while satisfying a non-blocking condition. By deciding a number m of output lines in each switch of an input-stage switch block and the number m of input lines in each switch of an output-stage switch block such that m≧2n−1+k−1 will be satisfied, it is possible to construct the input-stage switch block and output-stage switch block by switches for detailed packet-level switching and construct the intermediate-stage switch block with a large number of switches by single-function switches which perform only circuit switching.

### BACKGROUND OF THE INVENTION

1. Field of the Invention

The present invention relates to a non-blocking switching system and its switching method. More particularly, it relates to a three-stage, non-blocking switching system for detailed switching at the packet level.

2. Description of the Prior Art

Recently, with the dissemination of high performance computers among home users, the Internet which transmits a great deal of information has been used increasingly. The Internet employs a communications method called packet switching unlike conventional telephone communications that employ circuit switching in which a transmission line is occupied by the calling and called parties. Packet switching involves dividing information into small “packets” or data blocks, each of which contains destination and other control information, and sending them to recipients via a transmission line shared by many correspondents.

Transmission signals are delivered from a sender to the intended recipient via relay systems called nodes which are installed in the communication network. Each node contains line-switching units called cross-connect switches for switching paths. When cross-connect switches are turned on and off, appropriate paths between senders and recipients are connected. In the case of the circuit-switching method, a transmission signal inputted in a node is output to an output line only by routing.

On the other hand, with packet switching, transmission signals bound for different destinations are transmitted over a single transmission line. Consequently, it is necessary to check the destinations of transmission signals, and the signals transmitted on different input lines but bound for the same destination should be grouped together to be output to the same output line, while the signals transmitted on the same input line but bound for different destinations should be output to different output lines. Thus, transmission signals input in a node are output to output lines after being assembled and disassembled and being performed the routing at the packet level.

As the number of circuits increases with increase in the number of subscribers, the total numbers of input lines and output lines in the input-stage and output-stage also increase. This makes it necessary to expand the switches in nodes accordingly. Since it is difficult due to technical and cost problems to replace each switch with a large one, a method adopted involves enlarging the scale of an overall switching system by using a three-stage system consisting of unit switches relatively small in scale compared to conventional ones.

The cross-connect switch must satisfy a non-blocking condition which allows any idle input line to be connected to any idle output line regardless of the connection state of the paths set up between other input lines and other output lines, i.e., without reconfiguring switching paths to change existing paths.

The switching systems which satisfy the non-blocking condition include, for example, the three-stage CLOS switch (CLOS is the name of the inventor). A block diagram of this switch is shown in FIG. 11. If both the numbers of input lines and output lines in the intermediate-stage switch block 72 are k; the numbers of input lines, output lines, and switches (switches 711 to 71k arranged vertically in FIG. 11: the same applies hereinafter) in an input-stage switch block 71 are n, m, and k, respectively; and the numbers of input lines, output lines, and switches in an output-stage switch block 73 are m, n, and k, respectively, as shown in FIG. 11, it is known that to meet the non-blocking condition, the number m of switches 721 to 72m in an intermediate-stage switch block 72 must be at least m=2n−1. That is, the non-blocking condition is expressed as:

m≧2n−1 (1)

Configurations of conventional large-scale switching systems for packet switching which involves detailed switching at the packet level include a configuration which employs the three-stage CLOS switching system described above to perform detailed switching at the packet level in all the three switch blocks: input-stage, intermediate-stage, and output-stage switch blocks.

Another example of configuring a large-scale switching system involves enlarging the scale of ATM (asynchronous transfer mode) switches which require detailed switching at the cell level, similarly to the case in the packet switching method. For example, Japanese Patent Laid-Open No. 2-224547 and No. 7-327036 disclose methods for expanding the scale of ordinary ATM switches by connecting with STM (synchronous transfer mode) switches.

A first problem with the prior art is the difficulty of implementing a switching system for detailed switching at the packet level as a single large-scale switch. This is because a switch for packet switching needs a buffer for temporarily storing packets when interchanging packets, and thus expansion in scale will involve increases in the size and cost of the system.

A second problem is that enlarging the scale of a three-stage switching system for detailed switching at the packet level involves performing detailed switching at the packet level in all the input-stage switch block, intermediate-stage switch block, and output-stage switch block in order to satisfy the non-blocking condition, resulting in increased cost.

The reason will be as follows. When the three-stage switching system is constructed from three-stage CLOS switches to meet the non-blocking condition, Equation (1) must be satisfied as described above with reference to FIG. 11. For example, to increase the size of the switching system from 400×400 to 4000×4000, it is necessary to install 10 unit switches of 400×799 size in the input-stage switch block 71, 799 unit switches of 10×10 size in the intermediate-stage switch block 72, and 10 unit switches of 799×400 size in the output-stage switch block 73.

Alternatively, a switching system of 4000×4000 size can also be constructed from 20 unit switches of 200×399 size in the input-stage switch block 71, 399 unit switches of 20×20 size in the intermediate-stage switch block 72, and 20 unit switches of 399×200 size in the output-stage switch block 73. Either configuration requires a huge number of switches to be installed in the intermediate-stage switch block 72, which also needs a large number of high function switches to perform detailed switching at the packet level.

The technology of Japanese Patent Laid-Open No. 2-224547 described above, in which the intermediate-stage switches perform packet-level switching (rather than circuit switching), similarly to the case in the example of FIG. 11, has the same problems as the example of FIG. 11. Regarding the technology of Japanese Published Unexamined Patent Application No. 7-327036, since the intermediate-stage switches do not meet the non-blocking condition, it is not possible to connect any circuit entering an input-stage switch to any circuit in an output-stage switch depending on the states of circuit connections between the switches in the input stage, intermediate stage, and output stage.

### SUMMARY OF THE INVENTION

An object of the present invention is to provide an inexpensive three-stage switching system and a method thereof which perform detailed switching at the packet level in a manner similar to packet switching while satisfying a non-blocking condition.

The present invention provides a non-blocking switching system comprising an input-stage switch block, an output-stage switch block, and an intermediate-stage switch block installed between the input-stage and output-stage switch blocks, wherein the above described input-stage switch block and the above described output-stage switch block consist of switching means which performs switching at the packet level, and the above described intermediate-stage switch block consists of switching means which performs circuit switching.

Besides, the number m of output lines in each of the switching means composing the above described input switch block is m1+m2 or larger (where m1 is an integer which satisfies the above described non-blocking condition and m2 is an integer which indicates the number of additional output lines needed to distribute extra packets beyond the transmission capacity of the above described output lines). In this case, the above described input-stage switch block has J input lines (J=k×n), K output lines (K=k×m), and k switching means of n×m switch size; the above described intermediate-stage switch block has m switching means of k×k switch size which are connected to the output lines of the above described input-stage switch block; the above described output-stage switch block has L input lines (L=k×m) connected to the above described intermediate-stage switch block, M (M=k×n) output lines, and k switching means of n×m switch size; and the number m of output lines in each switching means of the above described input-stage switch block and the number m of input lines in each switching means of the above described output-stages witch block satisfy m≧m1+m2=(2n−1)+(k−1).

Also, the above described intermediate-stage switch block has a single switching means which satisfies the non-blocking condition; and the number m of output lines in each of the switching means composing the above described input switch block is m1+m2 or larger (where m1 is an integer which satisfies the above described non-blocking condition and m2 is an integer which indicates the number of additional output lines needed to distribute extra packets beyond the transmission capacity of the above described output lines). In this case, the above described input-stage switch block has J input lines (J=k×n), K output lines (K=k×m), and k switching means of n×m switch size; the above described intermediate-stage switch block has one switching means of N×N (N=k×m) switch size which is connected to the output lines of the above described input-stage switch block; the above described output-stage switch block has L input lines (L=k×m) connected to the above described intermediate-stage switch block, M (M=k×n) output lines, and k switching means of n×m switch size which perform switching at the packet level; and the number m of output lines in each switching means of the above described input-stage switch block and the number m of input lines in each switching means of the above described output-stage switch block satisfy m≧m1+m2=n+(k−1).

The present invention provides a switching method in a non-blocking switching system which comprises an input-stage switch block, an output-stage switch block, and an intermediate-stage switch block installed between the input-stage and output-stage switch blocks and in which the above described input-stage switch block and the above described output-stage switch block consist of switches which perform switching at the packet level, and the above described intermediate-stage switch block consists of switches which perform circuit switching, the above described switching method comprising: a first step of connecting the output lines of the above described input-stage switch block and the input lines of the above described output-stage switch block by operating the individual switching means of the above described intermediate-stage switch block in response to a request from a network; a second step of grouping packets, output to the above described input-stage switch block, by destination at the level of individual switches in the above described output-stage switch block with reference to destination information of the packets and assigning the grouped packets to the output lines of the above described input-stage switch block within the capacity of a transmission line; a third step of outputting the packets assigned to the output lines of the above described input-stage switch block to the above described intermediate-stage switch block; a fourth step of circuit-switching the above described packets in the above described intermediate-stage switch block and outputting them to the input lines of the above described output-stage switch block; and a fifth step of grouping packets, entered in the input lines of the above described output-stage switch block, by destination at the level of output lines in the above described output-stage switch block with reference to destination information of the packets and outputting the grouped packets to the output lines of the above described output-stage switch block.

The present invention provides a recording medium storing a program for making a computer execute a switching method in a non-blocking switching system which comprises an input-stage switch block, an output-stage switch block, and an intermediate-stage switch block installed between the input-stage and output-stage switch blocks and in which the above described input-stage switch block and the above described output-stage switch block consist of switches which perform switching at the packet level, and the above described intermediate-stage switch block consists of switches which perform circuit switching, the above described program comprising: a first step of connecting the output lines of the above described input-stage switch block and the input lines of the above described output-stage switch block by operating the individual switching means of the above described intermediate-stage switch block in response to a request from a network; a second step of grouping packets, output to the above described input-stage switch block, by destination at the level of output lines in the above described output-stage switch block with reference to destination information of the packets and assigning the grouped packets to the output lines of the above described input-stage switch block within the capacity of a transmission line; a third step of outputting the packets assigned to the output lines of the above described input-stage switch block to the above described intermediate-stage switch block; a fourth step of circuit-switching the above described packets in the above described intermediate-stage switch block and outputting them to the input lines of the above described output-stage switch block; and a fifth step of grouping packets, output to the input lines of the above described output-stage switch block, by destination at the level of output lines in the above described output-stage switch block with reference to destination information of the packets and outputting the grouped packets to the output lines of the above described output-stage switch block.

Now, the operation of the present invention will be described. In a three-stage switching system which meets the non-blocking condition, the number m of output lines in each switching means of the above described input-stage switch block and the number m of input lines in each switching means of the above described output-stage switch block satisfy m≧m1+m2=(2n−1)+(k−1). In other words, by assuming that m1 is a numeric value which satisfies the non-blocking condition given by Equation (1) above and by providing “m2=k−1” additional output lines needed to distribute extra packets beyond the transmission capacity of the input/output line (port) in each switch, it is possible to construct the input-stage switch block and output-stage switch block from switches for detailed packet-level switching and construct the intermediate-stage switch block with a large number of switches from single-function switches which perform only circuit switching.

### BRIEF DESCRIPTION OF THE DRAWINGS

FIG. 1 is a block diagram showing a three-stage switching system according to an embodiment of the present invention;

FIG. 2A shows an example for switching packet strings in the case where an intermediate-stage switch block consists of switches capable of detailed packet-level switching;

FIG. 2B shows an example for switching packet strings in the case where an intermediate-stage switch block consists of single-function switches for only circuit switching;

FIG. 3 shows an example for switching packet strings in a worst-case scenario for the example shown in FIG. 2B;

FIG. 4 shows a flowchart of operations according to the embodiment of the present invention;

FIG. 5A is a functional schematic block diagram of switches in an input-stage switch block;

FIG. 5B is a functional schematic block diagram of switches in an output-stage switch block;

FIG. 6 is a diagram showing an example of the operation of the input-stage switch block shown in FIG. 1;

FIG. 7 is a diagram showing another example of the operation of the input-stage switch block shown in FIG. 1;

FIG. 8 is a block diagram showing a three-stage switching system according to another embodiment of the present invention;

FIG. 9 is a diagram showing an example of the operation of the input-stage switch block shown in FIG. 8;

FIG. 10 is a diagram showing another example of the operation of the input-stage switch block shown in FIG. 8; and

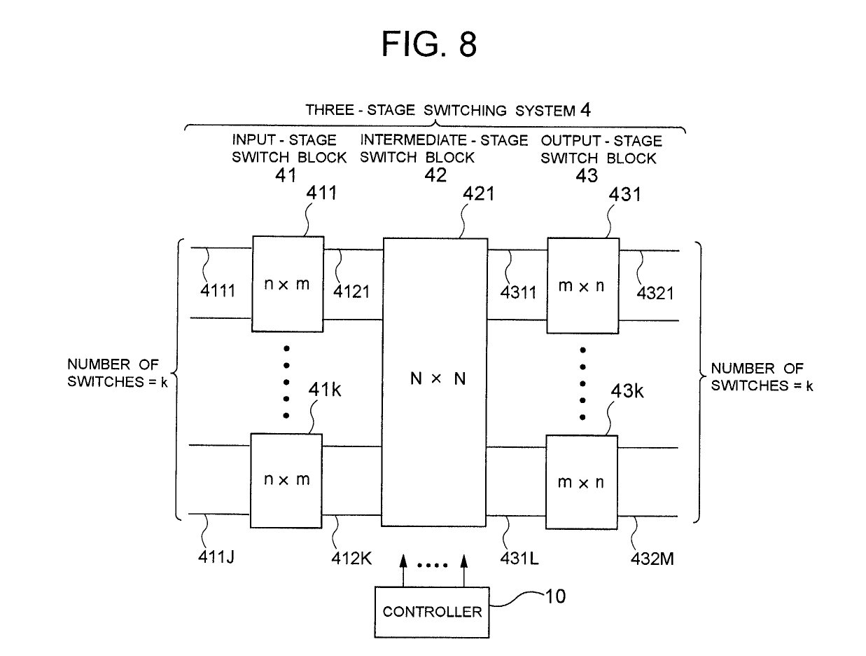

FIG. 8 is a block diagram showing a conventional three-stage switching system.

### DETAILED DESCRIPTION OF THE PREFERRED EMBODIMENTS

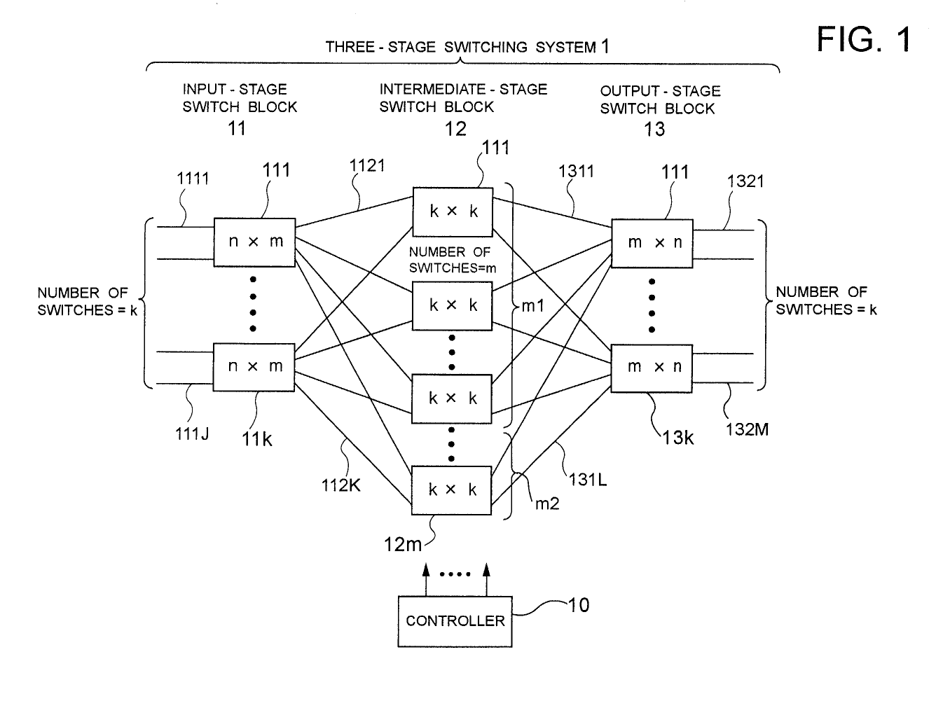

Now, preferred embodiments of the present invention will be described in detail with reference to the drawings. FIG. 1 is a block diagram illustrating the present invention. A three-stage switching system 1 according to the present invention consists of an input-stage switch block 11, intermediate-stage switch block 12, and output-stage switch block 13.

The input-stage switch block 11 has J input lines 1111 to 111J (J=k×n in this embodiment), K output lines 1121 to 112K (K=k×m in this embodiment), and k switches 111 to 11k of n×m switch size. The intermediate-stage switch block 12 has m switches 121 to 12m of k×k switch size which are connected to the output lines 1121 to 112K of the input-stage switch block. The output-stage switch block 13 has L input lines 1311 to 131L connected to the intermediate-stage switch block 12, M output lines 1321 to 132M, and k switches 131 to 13k of m×n switch size.

When detailed packet-level switching is not performed (circuit switching only), the number of output ports (the number of output lines as well: the same applies hereinafter) required for each of the switches 111 to 11k in the input-stage switch block 11 to satisfy the non-blocking condition of the three-stage CLOS switch is denoted by m1 (m1≧2n−1). When the packet-level switching according to the present invention is performed, the number of additional output ports required besides m1 is denoted by m2.

Although details about the number m2 of additional output ports will be described later, since the transmission capacities of each input line and output line in the switching system are fixed and the number of packets assigned to one line is limited to within this fixed transmission capacity, to assign any extra packet beyond this transmission capacity, additional output ports are needed.

Therefore, to perform packet-level switching with a satisfaction of the non-blocking condition, the number m of output ports required for each of the switches 111 to 11k in the input-stage switch block 11 is given by m=m1+m2.

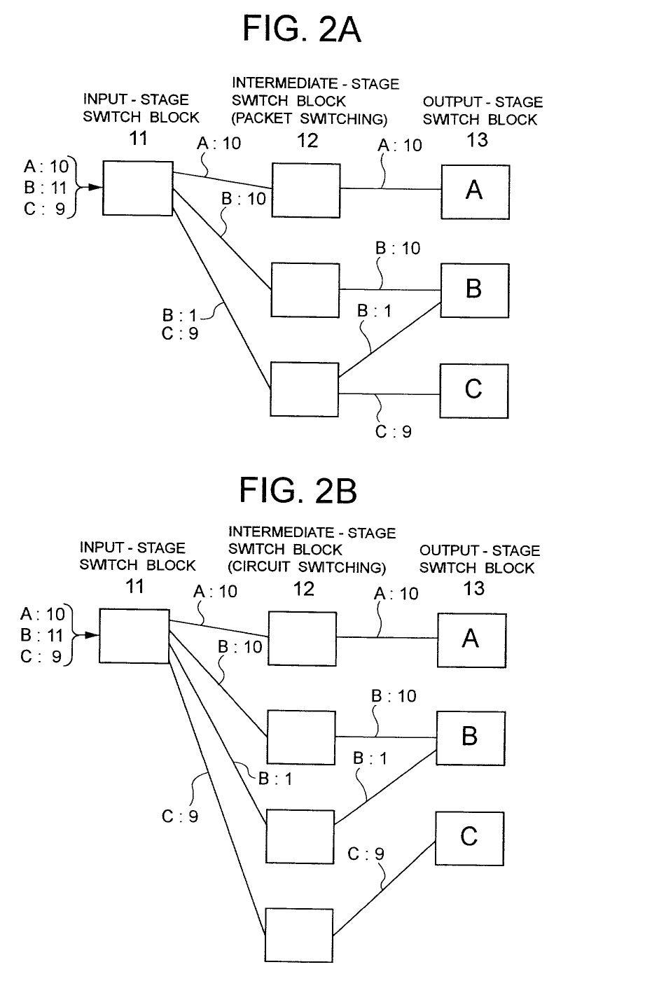

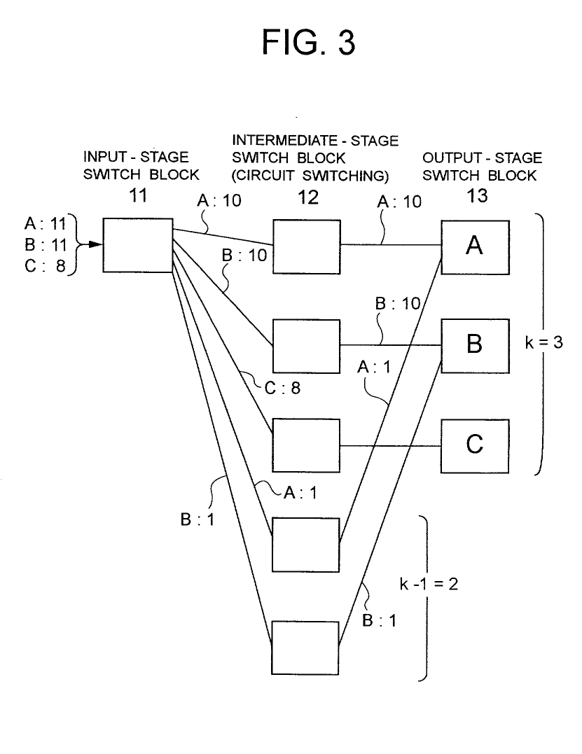

The number m2 mentioned above will be described in more detail with reference to FIGS. 2 and 3. FIGS. 2A and 2B are simplified diagrams illustrating the case in which the intermediate-stage switch block 12 consists of switches capable of detailed packet-level switching (FIG. 2A) and the case in which the intermediate-stage switch block 12 consists of single-function switches for only circuit switching (FIG. 2B), by comparing them under the same conditions.

In both FIGS. 2A and 2B, suppose the transmission capacity of each line (port) is 10 packets and the total number of packets inputted into one switch in the input-stage switch block 11 is 30. Suppose also that on a switch by packet-level switching, 10 packets are sent to destination “A,” 11 packets are sent to destination “B,” and 9 packets are sent to destination “C” in the output-stage switch block (for the sake of simplicity, it is assumed that there are three output-stage switches, which correspond to destinations A, B, and C, respectively).

In this case, if each of the switches in the intermediate-stage switch block 12 is capable of detailed packet-level switching, the packets are distributed by both input-stage switch block 11 and intermediate-stage switch block 12 as shown in FIG. 2A.

On the other hand, if each of the switches in the intermediate-stage switch block 12 performs only circuit switching, the packets must be distributed only by the input-stage switch block 11, resulting in increase in the number of switches in the intermediate-stage switch block 12 as shown in FIG. 2B. In this case, for switching the one packet for destination “B” in excess of the transmission capacity per output line of 10 packets and the nine packets for destination “C” which are within the transmission capacity, the intermediate-stage switch block 12, which performs only circuit switching, requires one switch more than in the case of FIG. 2A.

Furthermore, assuming that the transmission capacity of each line is 10 packets similarly to the case of FIG. 2 and that 30 packets are input in the switches in the input-stage switch block 11, FIG. 3 shows one of the worst cases when the intermediate-stage switch block 12 has only circuit-switching capability. Specifically, of the 30 packets, 11 packets are bound for destination “A,” 11 packets are bound for destination “B,” and 8 packets are bound for destination “C.” As can be seen from FIG. 3, this case requires two more switches in the intermediate-stage switch block 12 than in the case of FIG. 2A.

Generally, if the number of switches in the output-stage switch block 13 is k, the number of switches in the intermediate-stage switch block 12 must be increased by k−1. In the case of FIG. 1, for example, the number m of output lines (output ports) in the input-stage switch block 11 and the number m of input lines (input port) in the output-stage switch block 13 must be increased by m2=k−1 over m1 which satisfies the non-blocking condition given by Equation (1).

In the embodiment shown in FIG. 1, if the number of input ports in each of the switches 111 to 11k is n=200, the non-blocking condition of the three-stage CLOS switch given by m1=2n−1 equals 399. Also, if the number of switches in the input-stage switch block is k=20, the number of additional output ports to be newly installed, which is given by m2=k−1, equals 19. Therefore, the number of output ports in each of the switches 111 to 11k is given by m=m1+m2=399+19=418. Thus, switches 111 to 11k have a size of 200×418.

The intermediate-stage switch block 12 has m (also m=418) switches 121 to 12m of k×k (also k=20) switch size which are connected to the output lines 1121 to 112K of the input-stage switch block. The output-stage switch block 13 has L (L=k×m in this embodiment) input lines 1311 to 131L connected to the intermediate-stage switch block 12, M (M=k×n in this embodiment) output lines 1321 to 132M, and k switches 131 to 13k of m×n (also m=418, n=200) switch size.

The three-stage switching system 1 according to the present invention constitutes a large-scale switching system of 4000×4000 size with the input lines 1111 to 111J in the input-stage switch block 11 totaling k×n (=4000) and the output lines 1321 to 132M in the output-stage switch block 13 totaling k×n (=4000). A controller 10, which is implemented as a computer CPU or the like, controls the switch blocks 11 to 13 in response to a request from a transmission network.

The three-stage switching system 1 thus configured satisfies the non-blocking condition as long as a path determination request is made on a one-to-one basis because it meets the non-blocking condition of the three-stage CLOS switch given by Equation (1), m≧2n−1. Therefore, it can be said that the three-stage switching system 1 of the present invention is a non-blocking and three-stage switching system. In this three-stage switching system 1, the input lines 1111 to 111J of the input-stage switch block 11 and the output lines 1321 to 132M of output-stage switch block 13 are connected to respective transmission lines between nodes of a communication network.

Incidentally, the individual switches in this embodiment may be electric switches for electrical transmission signals or optical switches for optical transmission signals. Besides, this embodiment may employ switches for the same type of transmission signal or a combination of switches for different types of transmission signal, such as a mixture of optical switches and electric switches. However, when using a combination of switches for different types of transmission signal, photoelectric converters or electrooptic converters must be placed between the switches of different types to convert the signals to those compatible with the switches.

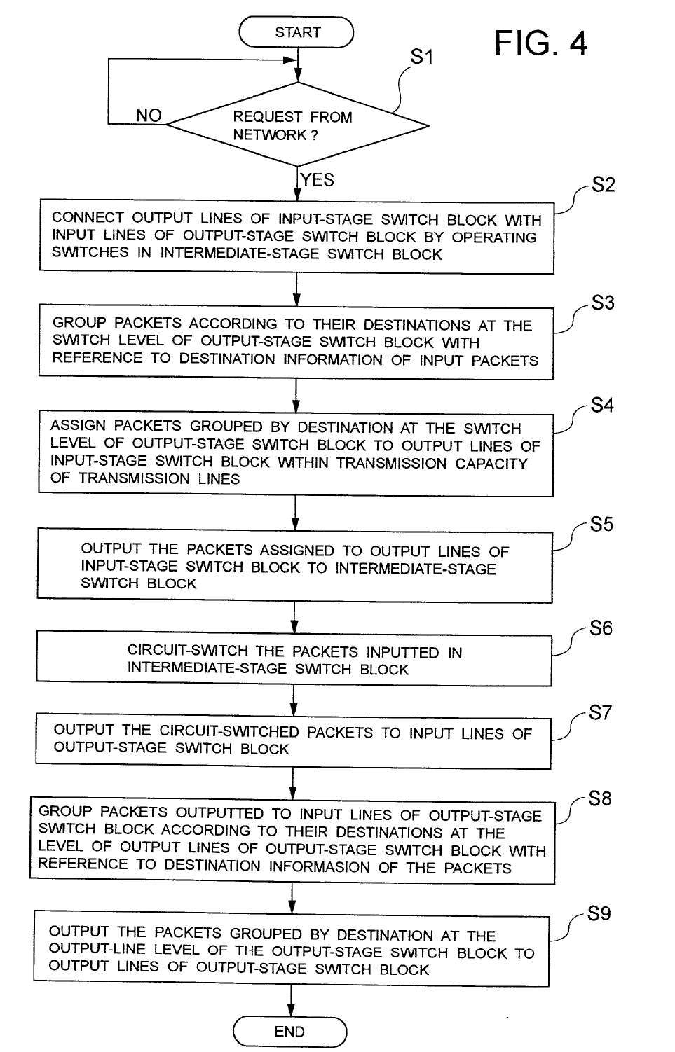

The operation of the embodiment in FIG. 1 will be described below. First, the flow of signals will be described with reference to the block diagram in FIG. 1 and flowchart in FIG. 4. Signals transmitted via transmission lines between nodes are input in the input lines 1111 to 111J of the input-stage switch block 11. In this case, a controller 10 starts control actions (Step S1) in response to control information for path determination received from a network management unit for centrally managing the transmission network if such a unit exists or in response to control information received from the preceding stage in case of distributed management in which the transmission network is managed by its constituent nodes.

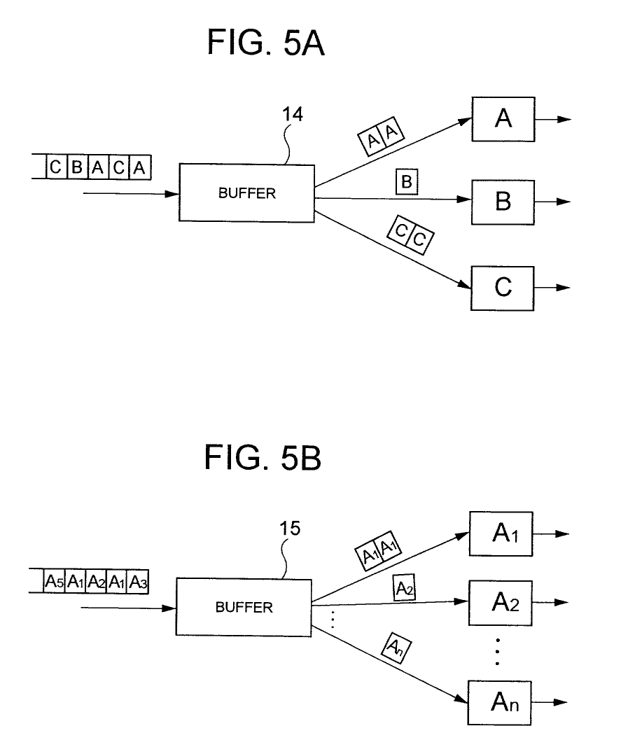

First, the controller 10 connects the output lines of the input-stage switch block 11 with the input lines of the output-stage switch block 13 by operating the switches in the intermediate-stage switch block 12 (Step S2). In this case, signals transmitted through each of the input lines 1111 to 111J contain packet signals bound for different destinations “A,” “B,” and “C” as shown in FIG. 5A (A to C are destinations at the switch level of the output-stage switch block 13 as described with reference to FIGS. 2 and 3).

FIG. 5A is a functional schematic block diagram of the switches 111 to 11k in the input-stage switch block 11. Input packets bound for different destinations are stored temporarily in a buffer 14, the packets are interchanged so that they will be grouped according to their destinations at the switch level of the output-stage switch block 13 (Step S3), and the interchanged packets are output to the output lines 1121 to 112K within the transmission capacity of the lines (Step S4).

The signals output from the input-stage switch block 11 are input in the switches 121 to 12m in the intermediate-stage switch block 12 (Step S5), and after routing (Step S6), they are output to the input lines 1311 to 131L of the output-stage switch block 13 (Step S7). Then, the signals undergo packet interchange and routing by means of the switches 131 to 13k of the output-stage switch block 13 so that the packets will be grouped according to their destinations at the level of the output lines 1321 to 132M (Step S8).

This is shown in FIG. 5B, which is a functional schematic block diagram of the switches 131 to 13k in the output-stage switch block 13. Packet strings grouped according to destinations at the switch level of the output-stage switch block 13 by the switches in the input-stage switch block 11 are stored temporarily in a buffer 15 (the figure shows packet strings which are bound for destination “A” at the switch level of the output-stage switch block 13 and have destinations A1, A2, . . . at the level of the output lines of the output-stage switch block 13). Then, packets are interchanged and grouped together according to their destinations at the output-line level of the output-stage switch block 13. Then, the packet strings are output to the appropriate output lines 1321 to 132M of the output-stage switch block 13 (Step S9) and output to transmission lines between nodes.

The operations according to the flowchart shown in FIG. 4 above are performed under the control of the controller 10 and can be implemented by configuring the controller as a computer as described above, storing a processing program prepared in accordance with the flow of FIG. 4 in a storage medium (not shown) in advance, and making the computer read and execute this program.

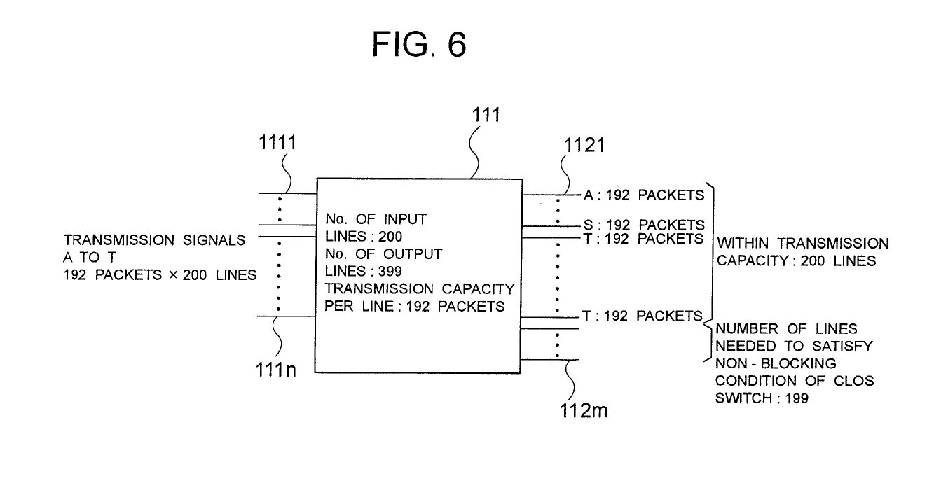

Next, the operation of the switches in the input-stage switch block 11 will be described with reference to FIG. 6. The first switch 111 (counting from the top of the figure: the same applies hereinafter) in the input-stage switch block 11 will be taken as an example. The switch 111 has 200 input ports (n=200), transmission capacity per port (line) of 192 packets, transmission capacity per packet of 50 MB/s, and total transmission capacity of 10 GB/s. Input lines 1111 to 111n into the switch 111 are connected to the input ports of the switch 111. Signals transmitted input to the switch 111 via the input lines 1111 to 111n.

The switch 111 interchanges inputted packets to group them according to their destinations at the switch level of the output-stage switch block 13 and outputs the interchanged packets to output lines 1121 to 112m. The second to 20th switches in the input-stage switch block 11 perform similar operations.

As shown in FIG. 6, after the transmission signal packets are interchanged, if the number of signal packets grouped at the level of the switches 131 to 13k in the output-stage switch block 13 is an integral multiple of 192 packets, which is the transmission capacity of each transmission line, the electrical signals after interchanging packets are reorganized into 200 lines. Since this is equivalent to circuit switching in which 200 lines input to the input-stage switch block 11, the non-blocking condition is satisfied if the number of output lines is 399.

Incidentally, the packets in FIG. 6 have been grouped according to destinations A t o T. These groups correspond to the signals transmitted to the switches 131 to 13k in the output-stage switch block 13. According to this embodiment, there are 20 switches in the output-stage switch block 13, and thus it is assumed that there are 20 packet groups A to T accordingly.

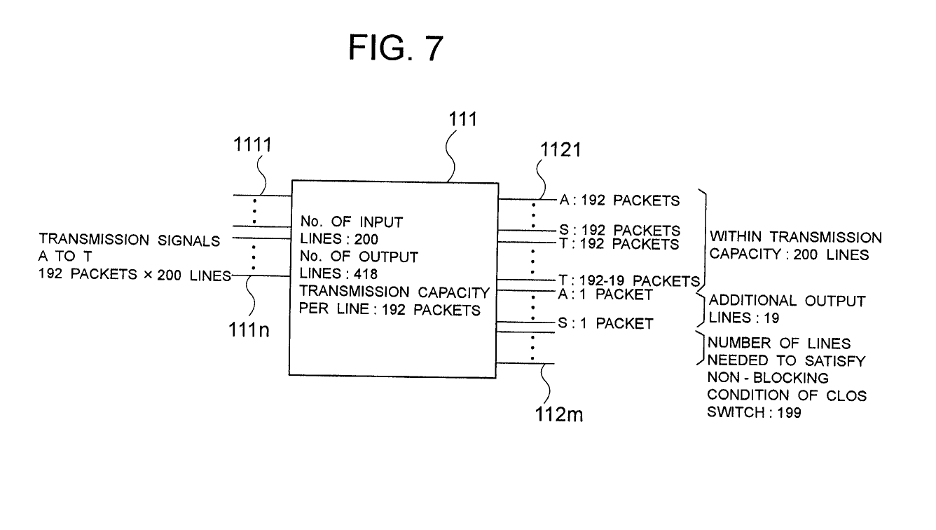

FIG. 7 shows operations performed when the number of signal packets grouped at the level of the switches 131 to 13k in the output-stage switch block 13 is not an integral multiple of 192 packets, which is the transmission capacity of each transmission line. According to this embodiment, the output-stage switch block 13 consists of 20 switches. Suppose there is a request to transmit a signal consisting of 193 packets, one packet in excess of the transmission capacity, with respect to each of the first to 19th output-stage switches (A to S). As for signals transmitted to the 20th output-stage switch (T), “200−19” lines transmit 192 packets and the remaining one line transmits “192−19” packets, i.e., the transmission capacity minus the 1×19 excess packets overflowing the first to 19th switches (A to S).

To accommodate overflow transmission signals, the input-stage switches 111 to 11k according to this embodiment have 418 (=m) output lines, which 19 (=m2) lines are added to 399 (=m1) lines required by the non-blocking condition of the CLOS switch. In other words, in order to accommodate overflow transmission signals, it is enough to newly provide “k−1” output lines, where k is the number of switches in the output-stage switch block 13.

As described above, any extra transmission signal beyond the transmission capacity of each line is output to the output lines provided additionally. The signals output to the output lines are routed to appropriate switches in the output-stage switch block 13 by the intermediate-stage switch block 12, undergo packet interchange and routing in the output-stage switch block 13, and enter respective transmission lines between nodes through the appropriate output lines 1321 to 132M.

FIG. 8 is a block diagram showing another embodiment of the present invention. A three-stage switching system 4 according to the present invention consists of an input-stage switch block 41, intermediate-stage switch block 42, and output-stage switch block 43.

The input-stage switch block 41 has J input lines 4111 to 411J (J=k×n in this embodiment), K output lines 4121 to 412K (K=k×m in this embodiment), and k switches 411 to 41k of n×m switch size.

If m1 denotes the number of output ports of each switch in the input-stage switch block 41 needed to satisfy the non-blocking condition of the entire three-stage switching system 4 when detailed packet-level switching is not performed and m2 denotes the number of output ports to be newly provided in each of the switches 411 to 41k to distribute extra packets when detailed packet-level switching is performed (this case will be described in relation to this embodiment), then m=m1+m2 is obtained.

If the number of input ports in each of the switches 411 to 41k is n=400, when a large-scale non-blocking switch 421 is provided in the intermediate-stage switch block 42, the non-blocking condition without packet-level switching is satisfied when m1=n. Thus, m1=400

Suppose the number of switches in the input-stage switch block 41 is k=10. IN the same way as the case of the above embodiment, the number of output lines to be newly provided is m2=k−1, and thus m2=9. Therefore, the number of output ports in each of the switches 411 to 41k is m=m1+m2=400+9=409. As can be seen from the above, the switches 411 to 41k has a size of 400×409.

The intermediate-stage switch block 42 has the large-scale switch 421 of N×N (N=k×m in this embodiment) switch size. The output-stage switch block 43 has L (L=k×m in this embodiment) input lines 4311 to 431L, M (M=k×n in this embodiment) output lines 4321 to 432M, and k (also k=10) switches 431 to 43k of n×m (also m=409, n=400) switch size.

The three-stage switching system 4 according to the present invention constitutes a large-scale switching system of 4000×4000 size with the input lines 4111 to 411J in the input-stage switch block 41 totaling k×n (=4000) and the output lines 4321 to 432M in the output-stage switch block 43 totaling k×n (=4000). The three-stage switching system 4 thus configured satisfies the non-blocking condition when intermediate-stage large-scale switch 42 consists of a single non-blocking switch 421 as long as a path determination request is made on a one-to-one basis. Thus, it can be said that the three-stage switching system 4 of the present invention is a non-blocking, three-stage switching system.

In this three-stage switching system 4, the input lines 4111 to 411J of the input-stage switch block 41 and the output lines 4321 to 432M of the output-stage switch block 43 are connected to respective transmission lines between nodes of a communication network.

Incidentally, the individual switches in this embodiment may be electric switches for electrical transmission signals or optical switches for optical transmission signals. Besides, this embodiment may employ switches for the same type of transmission signal or a combination of switches for different types of transmission signal, such as a mixture of optical switches and electric switches. However, when using a combination of switches for different types of transmission signal, photoelectric converters or electrooptic converters must be placed between the switches of different types to convert the signals to those compatible with the switches.

The operation of the second embodiment according to the present invention will be described with reference to FIGS. 8, 9, and 10. First, the flow of signals will be described with reference to FIG. 8. Signals transmitted from inter-node transmission lines enter the input lines 4111 to 411J of the input-stage switch block 41. The packet signals transmitted through the input lines 4111 to 411J of the input-stage switch block 41 have various destinations. First, the inputted packets are interchanged by the input-stage switch block 41 so that they will be grouped according to their destinations at the switch level of the output-stage switch block 43 and the interchanged packets are output to the output lines 4121 to 412K.

The signals output from the input-stage switch block 41 are input in the intermediate-stage switch block 42, and after routing, they are output to the input lines 4311 to 431L of the output-stage switch block 43. Then, the signals undergo packet-interchange and routing by means of the switches 431 to 43k of the output-stage switch block 13 so that the packets will be grouped according to their destinations at the level of the output lines 4321 to 432M and the interchanged packets are output to the output lines 4321 to 432K of the output-stage switch block 43, and then to transmission lines.

The above operations are performed under the control of the controller 10 according to the flowchart shown in FIG. 4, similarly to the case of the embodiment described earlier.

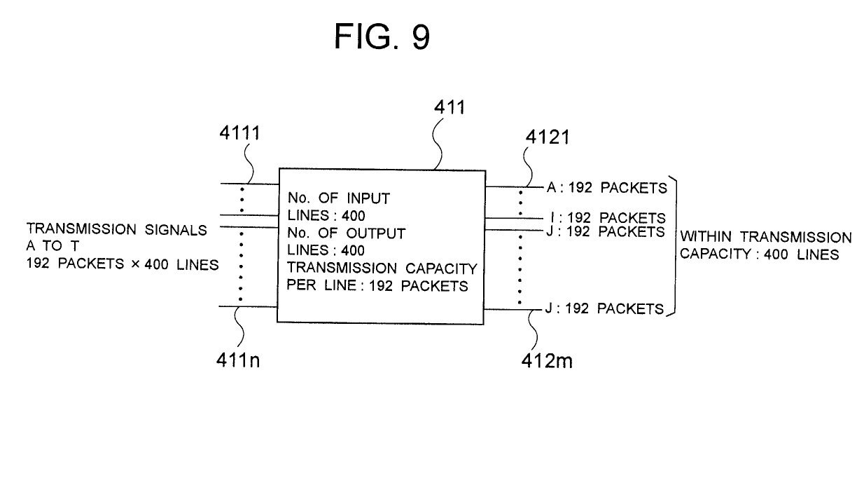

Next, the operation of the switches in the input-stage switch block will be described with reference to FIG. 9. The first switch 411 in the input-stage switch block 41 will be taken as an example. The switch 411 has 400 input ports (n=400), transmission capacity per port of 192 packets, transmission capacity per packet of 50 MB/s, and total transmission capacity of 10 GB/s. Input lines 4111 to 411n into the switch 411 are connected to the input ports of the switch 411. Signals transmitted enter the switch 411 via the input lines 4111 to 411n.

The switch 411 interchanges inputted packets to group them according to their destinations at the switch level of the output-stage switch block 43 and outputs the interchanged packets to output lines 4121 to 412m. The second to 20th switches in the input-stage switch block 41 perform similar operations.

As shown in FIG. 9, after the signal packets from the communication network are interchanged, if the number of signal packets grouped at the level of the switches 431 to 43k in the output-stage switch block 43 is an integral multiple of 192 packets, which is the transmission capacity of each transmission line, the signals after interchanging packets are reorganized into 400 lines. Therefore, since this is equivalent to circuit switching in which 400 lines enter the input-stage switch block 41, the non-blocking condition is satisfied if the number of output lines is 400 when the intermediate-stage switch block 42 consists of a large-scale non-blocking switch.

Incidentally, the packets in FIG. 9 have been grouped according to destinations A to J. These groups correspond to the signals transmitted to the switches 431 to 43k in the output-stage switch block 43. According to this embodiment, there are 10 switches in the output-stage switch block 43, and thus there are 10 packet groups A to J accordingly.

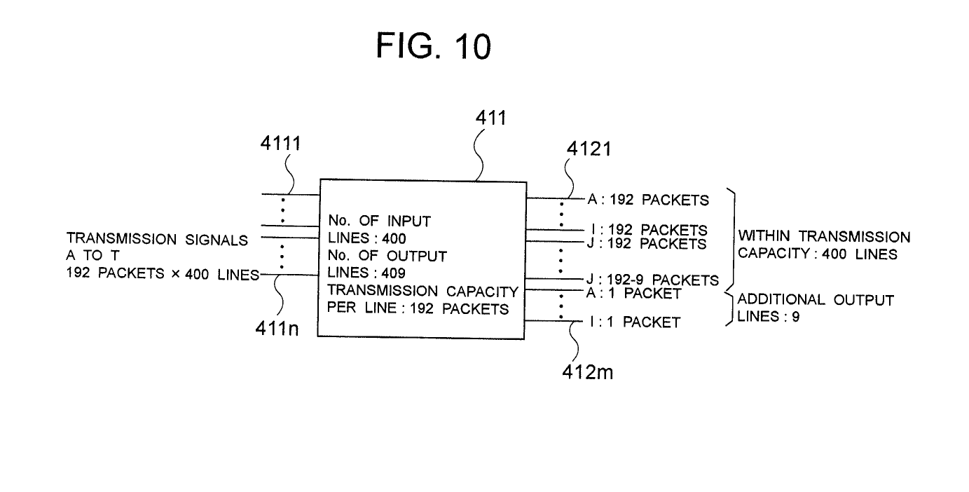

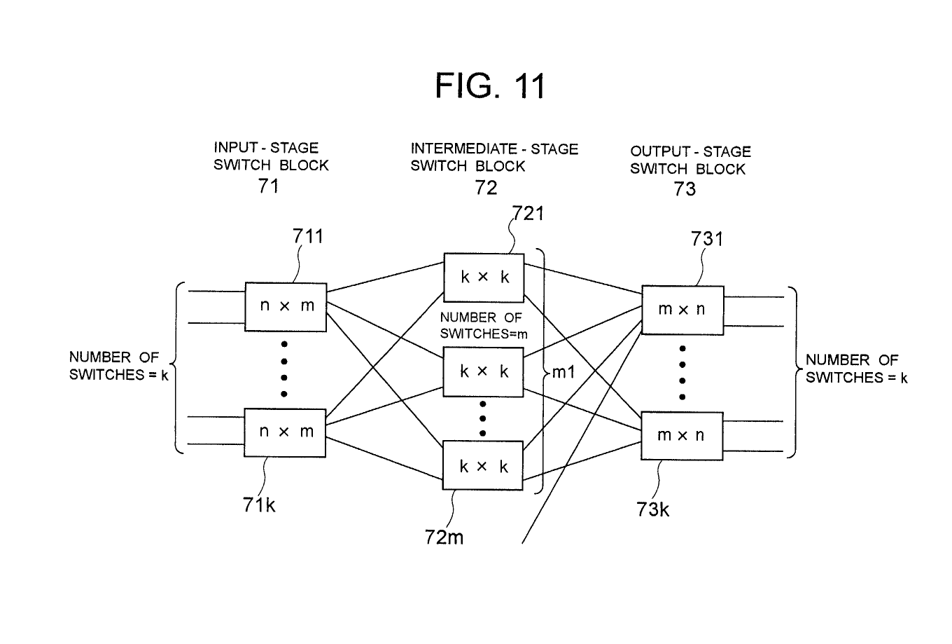

FIG. 10 shows operations performed when the number of signal packets inputted in the input lines 4111 to 411J of the input-stage switch block 41 is not an integral multiple of 192 packets, which is the transmission capacity of each transmission line. According to this embodiment, the output-stage switch block 43 consists of 10 switches. Suppose there is a request to transmit a signal consisting of 193 packets, one packet in excess of the transmission capacity, with respect to each of the first to 9th output-stage switches (A to I). As for electric signals transmitted to the 10th output-stage switch (J), “400−19” lines transmit 192 packets each while the remaining one line transmits “192−9” packets, i.e., the transmission capacity minus the 1×9 excess packets overflowing the first to 9th switches (A to I).

To accommodate overflow transmission signals, the input-stage switches 411 to 41k according to this embodiment have 9 additional output lines added to 400 (=m1) lines. The overflow transmission signals in excess of the transmission capacity are output to the additional output lines. In other words, in the same way as the case of the embodiment described earlier, in order to accommodate overflow transmission signals, it is enough to newly provide “k−1” output lines, where k is the number of switches in the output-stage switch block 43.

As described above, any extra transmission signal beyond the transmission capacity of each line is output to the output lines provided additionally. The signals output to the output lines are routed to appropriate switches in the output-stage switch block 43 by the intermediate-stage switch block 42, undergo packet interchange and routing in the output-stage switch block 43, and enter respective transmission lines through the appropriate output lines 4321 to 432M.

By providing a large-scale switch in the intermediate-stage switch block 42 as with this embodiment, it is possible to construct a large-scale switching system of 4000×4000 size with 10 switches of 400×409 size in the input-stage switch block 41 and 10 switches of 409×400 size in the output-stage switch block 43.

On the other hand, the embodiment shown in FIG. 1 described earlier employs small-scale switches in the intermediate-stage switch block 12 to construct a large-scale switching system of 4000×4000 size with 20 switches of 200×418 size in the input-stage switch block 11 and 20 switches of 418×200 size in the output-stage switch block 13.

When the two embodiments described above are compared, the embodiment in FIG. 8 which employs a large-scale switch is more advantageous because of the smaller number of switch elements. The number of paths between the input-stage and intermediate-stage as well as between the intermediate-stage and output-stage, are 409×10 lines in the case of the large-scale switch and 418×20 lines in the case of the small-scale switches, meaning that the use of the large-scale switch requires a smaller number of lines as well.

A first advantage of the present invention is that, when the scale of a conventional three-stage switching system with a switching device which performs detailed switching at the packet level in a manner similar to packet switching are expanded, it is possible to construct the intermediate-stage switch block by single-function switches which perform only circuit switching, by constructing the input-stage switch block and output-stage switch block by switches for detailed packet-level switching and providing each switch in the input-stage switch block with additional output lines equal in number to the number of switches in the output-stage switch block minus one.

A second advantage of the present invention is that, by constructing the intermediate-stage switch block by only a single function switches of performing circuit switching, it is possible to construct the intermediate-stage switch block from a single large-scale switch, which in turn makes it possible to expand the scale of a three-stage switching system without increasing the size or number of switches in the input-stage switch block and output-stage switch block. Furthermore, the number of lines connecting the input-stage and output-stage switch blocks with the intermediate-stage switch block can be reduced almost by half.

What is claimed is:

1. A non-blocking switching system comprising:
an input-stage switch block;
an output-stage switch block; and
an intermediate-stage switch block installed between the input-stage and output-stage switch blocks,
wherein said input-stage switch block and said output-stage switch block consist of switching means which performs switching at a packet level, and said intermediate-stage switch block consists of switching means which performs circuit switching.

2. The non-blocking switching system according to claim 1,
wherein the number m of output lines in each of the switching means composing said input-stage switch block is m1+m2 or larger (where m1 is an integer which satisfies a non-blocking condition and m2 is an integer which corresponds to the number of additional output lines needed to distribute extra packets beyond a transmission capacity of said output lines).

3. The non-blocking switching system according to claim 2,
wherein said input-stage switch block has J input lines (J=k×n), K output lines (K=k×m), and k switching means of n×m switch size;
said intermediate-stage switch block has m switching means of k×k switch size which are connected to the output lines of said input-stage switch block;
said output-stage switch block has L input lines (L=k×m) connected to said intermediate-stage switch block, M output lines (M=k×n), and k switching means of n×m switch size; and
the number m of output lines in each switching means of said input-stage switch block and the number m of input lines in each switching means of said output-stage switch block satisfy m≧m1+m2=(2n−1)+(k−1).

4. The non-blocking switching system according to claim 1,
wherein said intermediate-stage switch block has a single switching means which satisfies a non-blocking condition; and
the number m of output lines in each of the switching means composing said input switch block is m1+m2 or larger (where m1 is an integer which satisfies said non-blocking condition and m2 is an integer which indicates the number of additional output lines needed to distribute extra packets beyond a transmission capacity of said output lines).

5. The non-blocking switching system according to claim 4,
wherein said input-stage switch block has J input lines (J=k×n), K output lines (K=k×m), and k switching means of n×m switch size;
said intermediate-stage switch block has one switching means of N×N (N=k×m) switch size which is connected to the output lines of said input-stage switch block;
said output-stage switch block has L input lines (L=k×m) connected to said intermediate-stage switch block, M output lines (M=k×n), and k switching means of n×m switch size which perform switching at the packet level; and
the number m of output lines in each switching means of said input-stage switch block and the number m of input lines in each switching means of said output-stage switch block satisfy m≧m1+m2=n+(k−1).

6. The non-blocking switching system according to claim 1,
wherein said input-stage switch block, said intermediate-stage switch block, and said output-stage switch block are composed of electric switches.

7. The non-blocking switching system according to claim 1,
wherein said input-stage switch block and said output-stage switch block are composed of electric switches and said intermediate-stage switch block is composed of optical switches.

8. A switching method in a non-blocking switching system which comprises an input-stage switch block, an output-stage switch block, and an intermediate-stage switch block installed between the input-stage and output-stage switch blocks and in which said input-stage switch block and said output-stage switch block consist of switches which perform switching at a packet level, and said intermediate-stage switch block consists of switches which perform circuit switching, comprising:
a first step of connecting the output lines of said input-stage switch block and the input lines of said output-stage switch block by operating the individual switching means of said intermediate-stage switch block in response to a request from a network;
a second step of grouping together packets, which are entered in said input-stage switch block, by destination at the level of individual switches in said output-stage switch block with reference to destination information of the packets and assigning the grouped packets to the output lines of said input-stage switch block within a capacity of a transmission line;
a third step of outputting the packets assigned to the output lines of said input-stage switch block to said intermediate-stage switch block;
a fourth step of circuit-switching said packets in said intermediate-stage switch block and outputting said packets to the input lines of said output-stage switch block; and
a fifth step of grouping packets, which are entered in the input lines of said output-stage switch block, by destination at the level of output lines in said output-stage switch block with reference to destination information of the packets and outputting the grouped packets to the output lines of said output-stage switch block.

9. The non-blocking switching system according to claim 8,
wherein said input-stage switch block, said intermediate-stage switch block, and said output-stage switch block are composed of electric switches.

10. The non-blocking switching system according to claim 8,
wherein said input-stage switch block and said output-stage switch block are composed of electric switches and said intermediate-stage switch block is composed of optical switches.

11. A recording medium storing a program for making a computer execute a switching method in a non-blocking switching system which comprises an input-stage switch block, an output-stage switch block, and an intermediate-stage switch block installed between the input-stage and output-stage switch blocks and in which said input-stage switch block and said output-stage switch block consist of switches which perform switching at the packet level, and said intermediate-stage switch block consists of switches which perform circuit switching,
wherein said program comprises:
a first step of connecting the output lines of said input-stage switch block and the input lines of said output-stage switch block by operating the individual switching means of said intermediate-stage switch block in response to a request from a network,
a second step of grouping packets, which are entered in said input-stage switch block, by destination at the level of individual switches in said output-stage switch block with reference to destination information of the packets and assigning the grouped packets to the output lines of said input-stage switch block within the capacity of a transmission line;
a third step of outputting the packets assigned to the output lines of said input-stage switch block to said intermediate-stage switch block;
a fourth step of circuit-switching said packets in said intermediate-stage switch block and outputting them to the input lines of said output-stage switch block; and
a fifth step of grouping packets, which are entered in the input lines of said output-stage switch block, by destination at the level of output lines in said output-stage switch block with reference to destination information of the packets and outputting the grouped packets to the output lines of said output-stage switch block.
